(19) United States
(12) Patent Application Publication
(10) Pub. No.: US 2010/0181340 A1
(43) Pub. Date: Jul. 22, 2010

(54) System and method for creating and dispensing hair color

(76) Inventors: Mandolyn Wallace, Leander, TX (US); Jennifer Georges, Cheyenne, WY (US)

Correspondence Address: David E. Orr, 4616 NE 134th Street, Vancouver, WA, 98686, US

(21) Appl. No.: 12/321,233

(22) Filed: Jan. 17, 2009

(51) Int. Cl. B67D 7/06

(52) U.S. Cl. 222/144.5

(57) ABSTRACT

A hair-color dispensing apparatus configured to mechanically store a plurality of hair colors and developers and dispense quantized amounts on demand and also components able to electronically store hair color mixture. The apparatus comprises computer logic able to store and retrieve database records having information about hair colors and related data, such as textures, tints and styles. The apparatus is capable of receiving inputs related to a plurality of hair colors and from database records is able to derive hair colors therefrom. The apparatus then may display the mixing record, which may be further modified. The apparatus, then controls storage of hair coloring agents and causes the desired hair color to be made and dispensed. This apparatus may be used to mix and dispense other materials.

### FIELD

The present invention is an apparatus for mixing and dispensing hair coloring, wherein the apparatus comprises a computer system having a database related to hair colorings

### BACKGROUND

Historically, manufacturers of hair-coloring products have developed and marketed finite numbers of distinct hair colors, allowing the variety and breadth of their product lines to be limited by practical limitations of production. These limiting factors include—but are not limited to—the monetary impact of design, manufacture, and marketing, and the spatial restraints of retail product display.

Consumers are impacted by manufacturing limitations in the following ways: (1) hair-color products are dispensed and packaged off-site, resulting in finite product choices at the site of sale; (2) consumers can only purchase hair-coloring products that are available at the retail location they frequent; (3) a given product-line may or may not offer suitable hair-color for every interested consumer.

Similar cosmetic product dispensing and distribution constraints have previously been addressed by U.S. Pat. No. 6,672,341 B2 (Jan. 6, 2004), wherein an apparatus that allows for custom blends of cosmetic product (such as nail polish) to be produced at or near the point-of-sale is described. This device consists of a turntable equipped with multiple attached containers that are mounted symmetrically about the turntable's circumference. Rotation about a central axis of the turntable allows for manual and/or automated selection of container contents.

U.S. Pat. No. 7,347,344 (Mar. 25, 2008) discloses the specifications of a device that manually dispenses custom-chosen components of viscous fluids—such as paint, hair dye, shampoo, and make-up foundation—into detachable containers. Volumetric measuring of dispensed fluids is regulated by an electronic memory device and monitored by a mechanical weighing device. An additional container manages excessive fluid leakage.

European Patent Application No. 1,090,679 and European Patent Application No. 1,134,186 both describe fluid-dispensing devices that consist of a rotating turntable such as that of U.S. Pat. No. 6,672,341. Each mounted container is uniquely associated with a pump that serves to dispense quantized amounts of the container's contents. The latter European Patent differs from the former in its enhancement of the flexibility of the attachment of individual containers.

What is needed and has not yet been provided is a device for dispensing hair color that addresses the multiple issues associated with dispensing and distributing hair coloring.

### OBJECTS

Disclosed herein is an apparatus for producing and dispense hair color. Advantages of this apparatus are: (1) consumer choice will not be limited by predetermined hair-color selections; (2) retail locations can offer all possible color choices, not just a finite selection; (3) custom blended hair color will become available to all consumers, ensuring increased consumer satisfaction; (4) customer information will be electronically stored in the device's memory, minimizing possibly erroneous future hair-color choices; (5) product storage needs are eliminated, risk of damage to stored product is reduced, and human error (in hair dye preparation) is minimized.

The apparatus comprises memory and processing logic utilized to analyze and store hair colors and other data necessary to produce product and materials to duplicate a desired hair color for a user.

A first object of the invention is an apparatus that is programmed to produce hair coloring product that, when applied, will reproduce hair colors of all color shades and tones; according to formulae that is maintained in apparatus memory. Formulae in the apparatus use the three primary colors: red, yellow and blue and secondary colors. Secondary colors are—yellow & red=ORANGE, red & blue=VIOLET, & blue and yellow=GREEN.

A second object of the invention is an apparatus that dispenses four types of developers. 10, 20, 30 and 40 volume.

And another object is an apparatus that dispenses the correct amount of pigments into a crème base, the apparatus correctly adjusting the amount of pigment for the amount of color used.

And yet another object of the present invention is an apparatus that may be used for other purposes, such as dispensing paint, dyes or other materials that are mixed according to a formula or recipe.

Other benefits and advantages of the invention will appear from the disclosure to follow. In the disclosure reference is made to the accompanying drawings, which form a part hereof and in which is shown by way of illustration a specific embodiment in which the invention may be practiced. This embodiment will be described in sufficient detail to enable those skilled in the art to practice the invention, and it is to be understood that other embodiments may be utilized and that structural changes may be made in details of the embodiments without departing from the scope of the invention.

### SUMMARY

In accordance with the aforementioned objects, advantages and benefits, the present invention, disclosed in an exemplary embodiment is a hair-color dispensing apparatus having the following characteristics and capabilities: (1) an apparatus configured to electronically and mechanically store a plurality of hair colors and developers and dispense quantized amounts on demand; (2) an apparatus able to electronically store hair color mixture/formula information as well as specific client information, when applicable; (3) an apparatus that aesthetically resembles house paint apparatus in that the containers which hold final hair dye product are Teflon-coated metal cans, the hair dye applicators resemble paintbrushes, the hair dye application trays resemble house paint trays, and labels containing exact mixture information are printed by the device and placed on cans.

The apparatus as disclosed may also be used to dispense paint or other similar materials.

### BRIEF DESCRIPTION OF DRAWINGS

FIG. 1A illustrates a processing system that implements the apparatus of the invention.

FIG. 1B illustrates containment, and metering valves for dispensing hair coloring materials.

FIG. 2A shows an exemplary database record having personal information including a historical description of the person's natural hair color stored over a period of time that is maintained by the apparatus of the invention.

FIG. 2B shows an exemplary database record having personal information including a historical description of other person's hair colors that are stored over a period of time that is maintained by the apparatus of the invention.

FIG. 3A illustrates the apparatus retrieving and displaying a record of past hair colors of the person and mixing and dispensing colors according to an interpolation between two successive periods of time.

FIG. 3B illustrates the apparatus retrieving and displaying a record of past hair colors of the person and mixing and dispensing colors according to an interpolation between two successive periods of time.

### DETAILED DESCRIPTION

### An Exemplary Embodiment

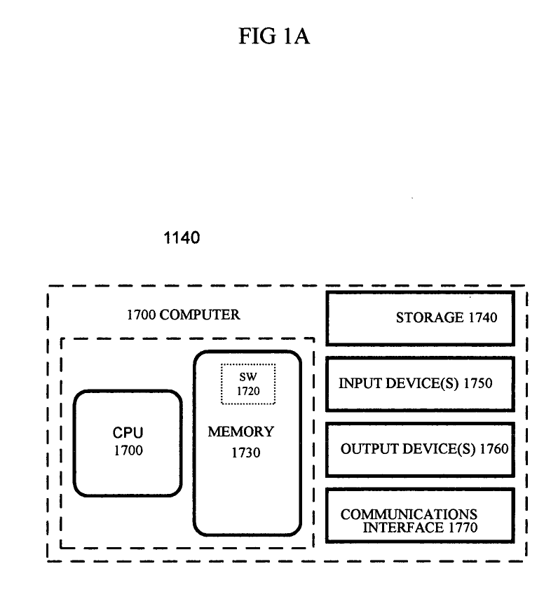

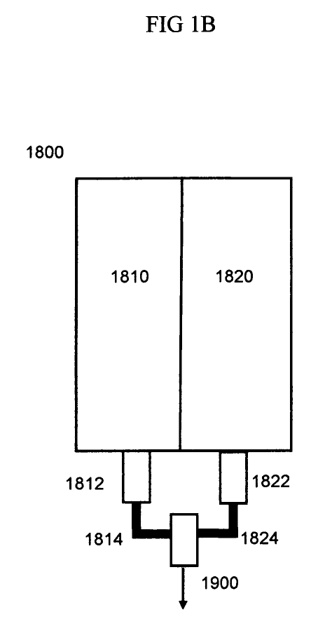

FIG. 1A-FIG. 3 illustrate an exemplary embodiment, which will be described in sufficient detail so that the invention can be made and used by skilled in the art of mechanical devices controlled by computer hardware and software.

While the apparatus is disclosed in the context of use for mixing and dispensing hair colors, this should be construed as a limitation. The apparatus may also be used to mix paints, adhesives, and other materials of the like.

### Processing Environment for the Hair Color Production and Dispensing Apparatus

The exemplary embodiment of the invention comprises containers storing materials used to make hair coloring dyes and other ingredients required for application to a person utilizing the apparatus.

The containers and material dispensing mechanisms, such as metering valves, are controlled by computer hardware and software logic. The computer hardware and software system operate according to formulae and mixing instructions stored in computer memory (including an externally accessed database), and based upon the formulae dispense materials into a mixing chamber, where the materials are combined or mixed to obtain a desired hair color when the materials are applied to a person. Once color is mixed algorithms programmed within the apparatus indicate the time period in which the formulation is good, that is to delineate the lapsed time within which the formulation must be applied.

Further, the computer logic system stores information about a user, such as data related to a persons hair color at particular times, so that the apparatus can duplicate a person's hair color at a specific date. The computer logic is programmed to derive hair color mixing instructions from a plurality of records in the database controlled by the computer logic.

The database and algorithms also comprise sufficient information to specify when a color cannot be achieved (for example color cannot lift color. If—a person has dark brown color level (3) and wants to go to a level (6), the algorithms would specify—pre-bleaching necessary.)

FIG. 1A illustrates a computer system including programming that may be used to control the apparatus. FIG. 1A and the following description should not be interpreted to limit the logic and programming of the apparatus as a means of storing hair color, hair texture and for controlling mixing valves used to mix and dispense hair color.

With reference to FIG. 1A, control of the hair color apparatus may be implemented; for example, within a computing environment 1140, which includes at least one processing unit 1700 and memory 1730. In FIG. 1A, this most basic configuration 1140 is included within a dashed line. The processing unit 1700 executes computer-executable instructions and may be a real or a virtual processor. In a multi-processing system, multiple processing units execute computer-executable instructions to increase processing power. The memory 1730 may be volatile memory (e.g., registers, cache, RAM), non-volatile memory (e.g., ROM, EEPROM, flash memory, etc.), or some combination of the two.

The memory 1730 stores executable software—instructions and data 1720—written and operative to execute and implement the software applications required for an interactive environment supporting practice of the invention. For example the software may comprise executable instructions to calculate quantities, volumes and times of application of materials (toners, colors, developers, etc.) used to produce a desired hair color. Software may also include accounting programs and calendars to support user appointments, such as times, dates and what was done with the apparatus, and hair colors mixed and dispensed.

The computing environment may have additional features. For example, the computing environment 1140 includes storage 1740, one or more input devices 1750, one or more output devices 1760, and one or more communication connections or interfaces 1770. An interconnection mechanism (not shown) such as a bus, controller, or network interconnects the components of the computing environment, for example with servo-mechanisms and sensor devices too sense and control metering devices dispensing hair coloring materials, and valves for storing and releasing constituents into mixers, and containers. An output device 1760 may include a printer, which prints labels used to describe color information related to color formulations produced by the apparatus. Labels once constructed may also be stored in a file within the database.

Typically, operating system software (not shown) provides an operating environment for other software executing in the computing environment, and coordinates activities of the components of the computing environment. Operating systems may comprise Microsoft Windows®, Apple OS, UNIX, LINUx, and so forth.

The storage 1740 may be removable or non-removable, and includes magnetic disks, CD-ROMs, DVDs, or any other medium which can be used to store information and which can be accessed within the computing environment. For example, the storage may store credit or debit balances, limits, and past transactions. The storage 1740 also stores instructions for the software 1720, and is configured, for example, to store processing algorithms, databases storing hair-color formulations, software systems, intermediate results and data generated from sensor inputs such as those received by mixing valves or dispensing valves..

The database includes at least one record having data related to a person's hair color at a specific date, and therefore store historical records of a person's hair texture, hair style and any other information about the person's hair. The database may have records that are digital images of the person's hair style and may also contain digital records of the person's hair color in high resolution color such as 24-bit RGB, and so forth.

The input device(s) 1750 may be a touch input device such as a keyboard, mouse, pen, or trackball, a voice input device, a scanning device, or another device that provides input to the computing environment. For audio or video, the input device(s) may be a sound card, video card, TV tuner card, or similar device that accepts audio or video input in analog or digital form. For example, the computer system may process and store audio records of a person's voice relating hair style or hair color information. The output device(s) 1760 may be a display, printer, speaker, or another device that provides output from the computing environment.

In particular, the input devices 1750 may comprise a video capture device, which may be used to acquire and store digital images of a person.

The communication interface 1770 enable the operating system and software applications to exchange messages over a communication medium with the sensor device, and servo-mechanisms in various instantiations of the apparatus of the invention. The communication medium conveys information such as computer-executable instructions, and data in a modulated data signal. A modulated data signal is a signal that has one or more of its characteristics set or changed in such a manner as to encode information in the signal. By way of example, and not limitation, the communication media include wired or wireless techniques implemented with an electrical, optical, RF, infrared, acoustic, or other carrier.

The communications interface 1770 is used to communicate with other devices such as cards or ATMs. For example, the interface 1770 may be attached to a network, such as the Internet, whereby the computing environment 1140 interchanges command, control and feedback signals with other computers, devices, and mixing or dispensing machinery. The processing system may also interface with on site computers already installed in a salon. For consumers—the processing system may e-mail formula home to own computer or to handheld.

### Database Records

The processing system shown in FIG. 1A and disclosed above maintains database records pertaining to users of the system, which may be professional and consumer users.

In general, the database stores data related to the user's hair colors and also may store data related to past use of the apparatus, such as time last used. Storage may comprise both word processed notes and images of the user captured by a digital camera an input device for the computer system shown in FIG. 1A and described above.

FIG. 1B illustrates a portion of the apparatus controlled and managed by the processing system shown in FIG. 1A and described above. In FIG. 1B, a component 1800 is shown comprising containers 1810 and 1820. These containers 1810 and 1820 may hold toners, dyes, developers and the like. Contents of the containers 1810 and 1820 are dispensed through metering valves 1812 and 1822, which meter according to mixing instructions held in the database of the processing system shown in FIG. 1A. From the metering valves 1812 and 1822 contents are fed by conduits 1814 and 1824 into a mixing valve 1900 and thence out to be applied.

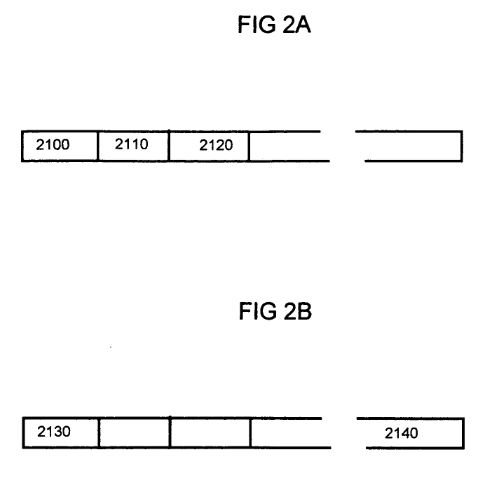

A time-related sequence of records may be stored for each user, such as the time and date of the hair color stored in a digital image For example, as shown in FIG. 2A, the database may contain records related to personal data such a user's hair styles 2100 and colors 2110-2120 at a particular date or age of the user.

Color related data may comprise a plurality of data items related to tints, developer types and quantities required to produce a particular hair color. These data items may also be in the form of mixing formulae related to quantities of materials used to mix a color and may also include developer times to achieve a particular effect.

With reference to FIG. 2B the database may also contain records pertaining to other person's hair colors 2130- 2140 such as celebrities, from which hair colors may be derived.

### Examples of Applications of the Apparatus

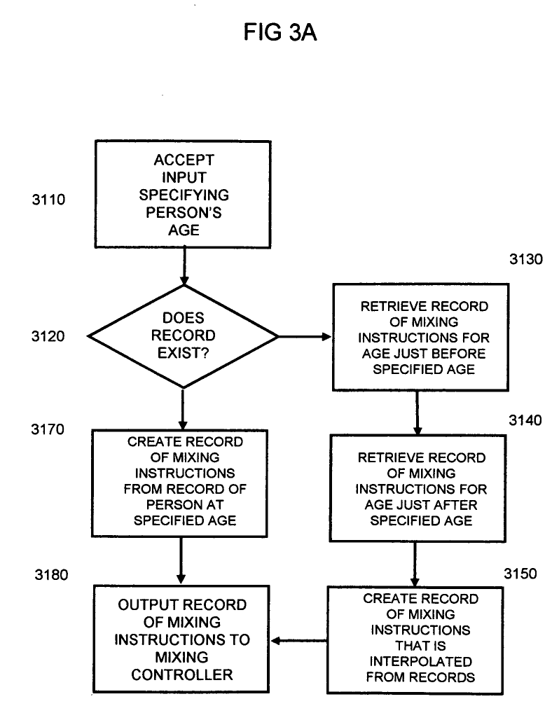

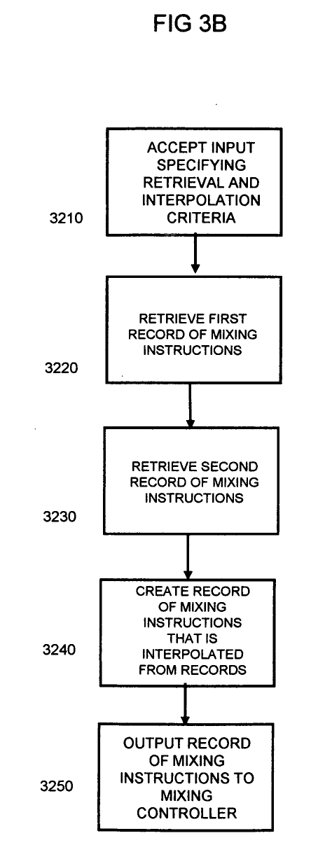

FIG. 3A shows a first example of the application and use of the apparatus by means of the computer logic and programming shown in FIG. 1A.

In FIG. 3A, the computer accepts input 3110 that relates to the age of the user. In step 3220 if the record exists, an output record is created 3170 is created from the user record retrieved. This record is then output 3180 to control mixing valves and to dispense base colors in containers controlled by the computer logic of FIG. 1A. This record may be modified to change the mixing instructions to modify the tint or highlighting of the color, when produced.

Again, with respect to FIG. 3A, if the record does not exist two records are retrieved. In step 3130 a record is retrieved of the user's hair just before the age specified. Then in step 3140, a second record is retrieved of the person's hair color just after the age specified 3140. In step 3150, a new record is created of mixing instructions derived from interpolating colors from the two ages. This record may be further modified before it is output in step 3180.

FIG. 3B shows a second use of the apparatus. In FIG. 3B, the steps shown are executed to produce a hair color that is the combination of two other colors. For example, the user's hair color may be modified according to anther person's hair color. In FIG. 3B, in step 3210, the computing logic of FIG. 1A accepts as input criteria for retrieving database records used to derive a hair color. As an example, the hair color may be derived from modifying a second person's hair color according to a third person's hair color. In step 3220, the first specified record is retrieved, and in step 3230 the second record is retrieved. In step 3240, the mixing instructions of the two records are combined according to criteria specified in step 3210. And in step 3250, the record of mixing instructions is output for display, possible modification and use to control the mixing and dispensing mechanisms used by the apparatus.

### DISCLOSURE SUMMARY

In the preceding disclosure the apparatus of the invention was described in terms of an exemplary embodiment and two cases of use. Since other variants and modifications of the apparatus are possible, the scope of the present invention is most properly defined by the claims that follow.

What is claimed is:

1. A hair-color dispensing apparatus configured to mechanically store a plurality of coloring materials, to dispense quantized amounts on demand, the apparatus comprising computer logic able to store and retrieve database records having information about colored objects and related data, such as textures, the apparatus capable of receiving inputs related to a plurality of colored, the computer logic utilizing database records to derive colors therefrom, the apparatus displaying a color mixing record, which may be further modified, the apparatus controlling storage of coloring agents, and causing the desired hair color to be made and dispensed.

2. The apparatus of claim 1, wherein the coloring materials are hair colors, coloring agents and the colored objects are human hair.
